(19) United States
(12) Patent Application Publication
(10) Pub. No.: US 2025/0123859 A1
(43) Pub. Date: Apr. 17, 2025

(54) A SYSTEM AND METHOD FOR USER RANKING AND ADAPTATIONS THEREOF FOR VOICE BASED INTERACTIONS

(71) Applicant: HISHAB INDIA PRIVATE LIMITED, New Delhi (IN)

(72) Inventors: Kai Samuel David Erik KARREN, Saarbrucken (DE); Michael SCHMITZ, Saarbrucken (DE); Zubair AHMED, New D.O.H.S, Mohakhali (BD)

(21) Appl. No.: 18/682,138

(22) PCT Filed: Aug. 5, 2022
(86) PCT No.: PCT/IN2022/050705

§ 371 Date: Feb. 8, 2024

(30) Foreign Application Priority Data
Aug. 8, 2021 (BD) P/BD/2021/000247

(51) Int. Cl. G06F 9/451; G06F 3/16

(52) U.S. Cl. CPC G06F 9/451; G06F 3/167

(57) ABSTRACT

The present invention relates to systems and methods for adapting elements of a user interface of an interactive voice response system in a voice-based interaction based on rank of a user and more particularly to ranking user for their expertise. The method of ranking the user comprises a dialogue engine receiving information related to a plurality of attributes for a voice-based interaction. A user rank classifier determines user rank and updates a user model by a user model update component. Further, the dialogue engine adapts and provides the user with a user interface based on the user's rank corresponding to his expertise thereby, enhances engagement during interaction. This makes the interface more efficient, approachable and user-friendly. Moreover, it saves time and cost for both the system operations and the user.

### FIELD OF INVENTION

The present invention relates to ranking for a user of an interactive voice response system and more particularly to systems and methods for adapting the elements of a user interface based on the rank of the user.

### BACKGROUND OF THE INVENTION

Currently, a plethora of tools serving various purposes such as banking, shopping and entertainment etc. have been designed that are deeply embedded in the fabric of modern society. These tool's user interfaces (UIs) and their functionalities often fail to take into consideration a design that serves all users and logic of operation in order to reach a larger number of potential customers from beginners to advanced rank of users. People who are beginners, or lack tech literacy or have not been familiar with related UIs, find it difficult to keep track of their information which may result in inaccuracy in their assessments and judgements. Significant difficulties are experienced by users in an applications user interface that is new or infrequently visited by them.

Systems frequently have difficulty marshalling user interests, preferences and experience. The tools often do not have enough information for providing a customized UI and functionality according to specific user expertise.

Often it is difficult for a tool to accommodate and execute the complexity level, in terms of user interface and functionality, for both expert and beginner users. For example, if a tool's UIs and functionalities are too complex for beginner rank of users to navigate, they tend to abandon it, even if they are suitable for more experienced users. Therefore, options to start from scratch along with a demo or a user's guide, so as for the users understanding of the application must be available for ease of understanding.

On the other hand, a too simplistic UI may be convenient for a beginner user but it would prevent an intermediate or an advanced user to take full advantage of the application features. For example, the same user guide or options to start from scratch is insignificant and a waste of time for a user who is a regular visitor of the application.

With different ranks of user expertise, the existing systems and users have often encountered difficulties managing information. Therefore, systems and methods are needed in order to determine the rank of user expertise and adapt the user interface and functionalities of the application based on the determined user rank.

### SUMMARY OF THE INVENTION

The present invention describes a method and a system for ranking a user and adapting a user-interface of an interactive voice response system according to a user's expertise corresponding to a voice-based interaction. The method of ranking a user based on user expertise comprises a dialogue engine receiving information related to a plurality of attributes from a user during the voice based interaction. A user rank classifier determines a first user-score-threshold and a second user-score-threshold corresponding to the plurality of attributes. A user rank classifier analyzes the information related to the plurality of attributes received from the user through a user model and a user model update component. The user model update component speculates and monitors the interaction session with the user and updates the user model accordingly. The method of ranking a user based on user expertise comprises steps of assigning a first user-score to the user based on the analysis of corresponding information related to the plurality of attributes received from the user and then assigning a user rank to the user based on the user-score. Further, the dialogue engine adapts and provides the user with a user-interface based on the user's rank corresponding to his expertise.

As a result, this invention can be used to measure the expertise of a user associated with a service platform and provide personalized services for ease of use. The system, thereby is tailored and aligned as per the user's needs and interests therefore, reduces user errors and fuels/enhances engagement in interaction sessions. This makes the interface more efficient, approachable and user-friendly. Moreover, it saves time and cost for both the system operations and the user usage.

### BRIEF DESCRIPTION OF DRAWINGS

FIG. 1A is a block diagram illustrating the data flow between a user and a system for determining the user's rank of expertise and adapting and configuring the user interface correspondingly.

FIG. 1B is a flowchart illustrating a scoring process in order to determine the user rank corresponding to a user's expertise.

FIG. 1C is a graphical representation illustrating the user ranks corresponding to multiple thresholds.

FIG. 2A is a flowchart illustrating a method to score a user to determine the user rank corresponding to a voice-based interaction.

FIG. 2B is a flowchart illustrating an exemplary scenario to score a user to determine the user rank corresponding to a voice-based interaction.

FIG. 3 is a flowchart illustrating an exemplary scenario to route and navigate a user through the user interface based on the user rank.

### DETAILED DESCRIPTION OF THE INVENTION

Described herein are systems and methods for determining a domain or a use case switch suggestion in a human-computer conversation. The systems and methods are described with respect to figures and such figures are intended to be illustrative rather than limiting to facilitate explanation of the exemplary systems and methods according to embodiments of the invention.

Described herein are methods and systems of adapting user-interface of an interactive voice response system according to a user's expertise corresponding to a voice-based interaction and the usage of the system. The systems and methods are described with respect to figures and such figures are intended to be illustrative rather than limiting to facilitate explanation of the exemplary systems and methods according to embodiments of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

As used herein, the term “network” refers to any form of a communication network that carries data and is used to connect communication devices (e.g. phones, smartphones, computers, servers) with each other. According to an embodiment of the present invention, the data includes at least one of the processed and unprocessed data. Such data includes data which is obtained through automated data processing, manual data processing or unprocessed data.

As used herein, the term “artificial intelligence” refers to a set of executable instructions stored on a server and generated using machine learning techniques.

Although the following description uses terms “first,” “second,” etc. to describe various elements, these elements should not be limited by the terms. These terms are only used to distinguish one element from another. For example, a first intent could be termed a second intent, and, similarly, a second intent could be termed a first intent, without departing from the scope of the various described examples.

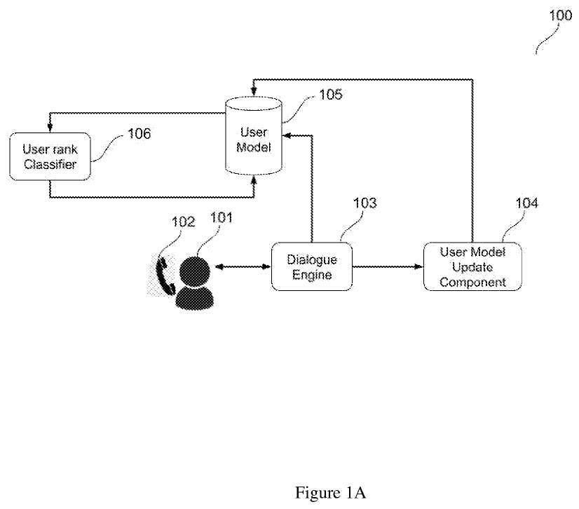

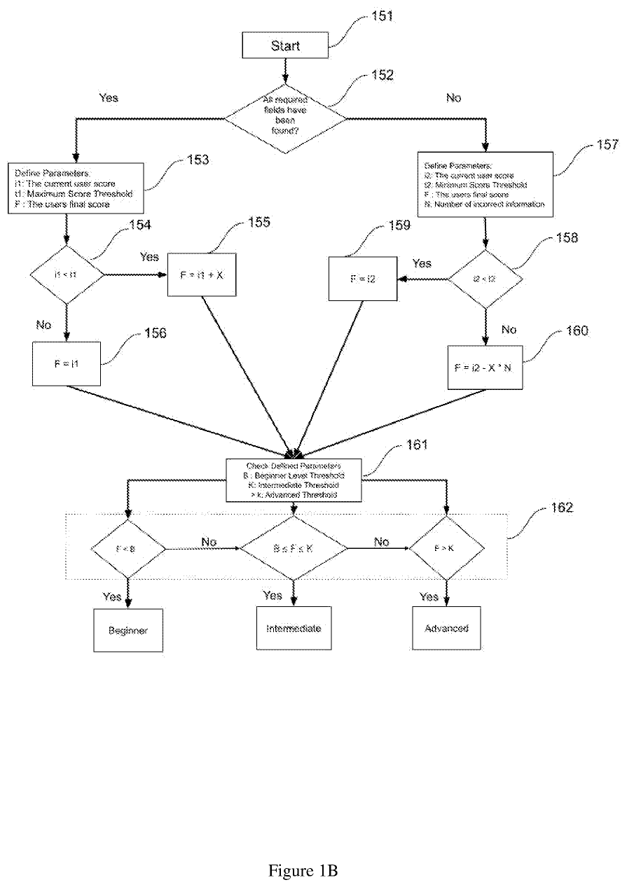

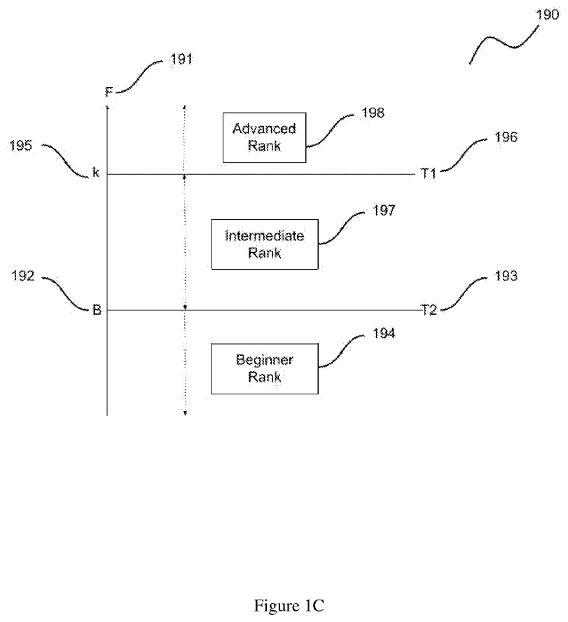

FIG. 1A illustrates a diagram illustrates data flow between a human and an interactive voice response (IVR) communication system 100 for determining the rank of user expertise for adapting and for correspondingly configuring the user interface in accordance with one or more aspects of the present invention. In this example, the disclosed IVR communication system 100 includes a dialogue engine 103, a user model update component 104, a user model 105, and a user rank classifier 106.

A user 101 initiates a call to IVR communication system 100 using client device 102. The call may be transmitted over a phone gateway, not illustrated herein, of a telecom operator network and further routed to the dialogue engine 103. The client device 102 corresponds to a wide variety of electronic devices. According to an embodiment of the present invention, the client device 102 is a smartphone or a feature phone or any telecommunication device such as an ordinary landline phone. Client device 102 acts as a service request means for inputting a user request. According to an embodiment of the present invention, the service request from the client device 102 is communicated to the dialogue engine 103 through a telecommunication network. According to yet another embodiment of the present invention, the service request from the client device 102 is communicated to the dialogue engine 103 using an application over the smartphone using data services which may or may not use a telecommunication network.

The user 101 uses client device 102 over a call to input service requests such as, to receive information, and initiate various processes that may be a part of the service requests to the dialogue engine 103. The dialogue engine 103 then employs one or many techniques for further processing and also, further transmitting extracted information from the interaction session to user model update component 104 and user model 105. When the user 101 uses client device 102 to input voice for a service request to the dialogue engine 103, the input voice of the user is processed using a method and system for speech to text translation of the incoming voice of the user. In this example, artificial intelligence techniques are employed to collect data from several users or an individual user to extract key terms indicative of user preferences.

Dialogue engine 103 provides a user interface between the user and the services mainly by engaging in a natural language dialogue with the user. The dialogue includes questions requesting one or more aspects of a specific service, such as asking for information. In this manner, IVR communication system 100 may also receive general conversational queries and engage in a continuous interaction session with the user through the dialogue engine 106.

The user model update component 104 is configured to monitor and speculate the interaction session between the user 101 and the dialogue engine 103, and generate or update a user rank score associated with the user 101 in the interaction session. The user model update component 104 is further capable of predicting an intent of the user 101, recognize an error, and/or a difficulty the user may be experiencing in the session, and update the user model 105 associated with the user 101 with corresponding relevant information. The user model 105 is also further updated with a user rank score, associated with the user 101, received from the user model update component 104 while assigning a score for one or more attributes in the user model 105.

User model 105 includes a data structure or other unit of data configured to store information about a user for providing a plurality of personalized services in a step manner wherein the number of steps is dependent on the user's rank. The plurality of services includes providing at least one of: financial transaction management, sale and purchase of goods and services.

The user model 105 includes information about the user 101. For example, the information corresponding to the user model 105 includes one or more identifiers for user 101 such as user IDs, user names, and other self-identifying information for the user. The user model 105 may also include user demographic information such as the user's age, gender, occupation, education information (e.g., education level, ranks etc.), or one or more locations associated with the user (e.g., the user's home, the user's places of work, places the user frequently visits, etc.). User model 105 may be generated and updated over one or more interactions with user 101. For example, each time the user 101 interacts with the IVR communication system 100 in FIG. 1, the user model update component 104 learns new information about user 101. The IVR communication system 100 then updates and stores the new information and also updates the user model 105 associated with the user.

The user model 105 further connects to the user rank classifier 106. The user rank classifier 106 verifies and determines the one or more attributes for the user model 105 and is configured to classify the user to a corresponding rank of expertise based on information including previously stored user rank score received from the user model 105 associated with the user 101. For example, the user 101 may be classified as a beginner, an intermediate or an advanced rank of user based on the corresponding user rank score received from the user model associated with the user.

The user rank classifier 106 is further capable of generating a table for ranks of user expertise corresponding to a range or specified values in order to classify users based on their expertise which is explained later in the specification in reference to FIG. 1B. It is to be appreciated that the user rank classifier 106 is also capable of classifying the one or more attributes included in the user model 105 and the user rank classifier 106 is further trained using training data received from the user model. The training data may include for example, but not limited to, features and attributes for a plurality of users corresponding to similar responses or difficulties and errors. The user rank classifier 106 is further capable of analyzing the received training data and employing deep learning on the information received from the data to train, develop and update machine learning models to predict the rank of expertise, actions and intents related to services and queries.

After the user rank classifier 106 validates and determines and classifies a user such as user 101 to a rank of expertise, the user rank classifier 106 updates the user model 105 with the corresponding rank of expertise associated with the user. The dialogue engine 103 then configures and modifies the user interface for the user 101 based on the user rank information received from the user model associated with the user 101.

FIG. 1B is a flowchart illustrating a scoring process 150 to determine the rank of user expertise in an interaction between the user and the IVR communication system 100 in accordance with one or more aspects of the present invention. According to an embodiment of the present invention, the plurality of ranks of user expertise include at least: a beginner, an intermediate, and an expert.

The scoring method 150 is used to evaluate the user's rank of expertise based on a first user rank score and the user information provided. The process starts at step 151. At step 152, the IVR communication system 100 determines if all fields of information are satisfied and assigns a first user-score to the user.

If all fields of information are satisfied at step 152, then in the next step at 153, the parameters are determined which may include for example, but not limited to:
i₁: first user-score
T₁: First threshold score
F: the users final user-score

Then in the next step at step 153, the IVR communication system 100 determines the relationship between the first user-score (i₁) and the first threshold score (T₁).

If the first user-score (i₁) is determined to be less than the first threshold score (T₁), then in the next step, at step 155, the first user-score (i₁) is incremented by an additional value of x.

If the first user-score (i₁) is determined to be greater than the first threshold score (T₁), then in the next step, at step 156, first user-score (i₁) is calculated as the user's final score (F) associated with the user.

Referring back to step 152, if all fields of information are not satisfied, then in the next step at 157 the parameters are determined which may include for example, but not limited to:
i₂: first user-score
T₂: Second threshold score
N: Number of incorrect information
F: The user's final user-score

Then in the next step at step 158, the IVR communication system 100 determines the relationship between the first user-score (i₂) and the second threshold score (T₂).

If i₂ is determined to be less than the second threshold score (T₂), then in the next step, at step 159, the first user-score (i₂) is calculated as the final score associated with the user.

If the first user-score (i₂) is determined to be greater than the second threshold score (T₂), then in the next step, at step 160, the first user-score (i₂) is evaluated over received information for one or more attributes and for each incorrect information associated with the one or more attributes, a value of X is decremented. Therefore, for N number of incorrect information, a total value of N*x is decremented from the first user-score (i₂). The final score (F) for the associated user is then calculated as the total value when N*x is decremented from i₂ (i.e., F=i2−N*x).

After determining the final score at step 156 or step 160, in the next step, at step 161, the IVR communication system 100 determines the defined parameters for rank of user expertise ranges and thresholds. The plurality of ranks of user expertise may include for example, but not limited to: a beginner, an intermediate, and an expert.

The parameters may be included for example, but not limited to, in a table, as illustrated below in table 1.

TABLE 1

| user-score | User Expertise rank |
|---|---|
| F < B | Beginner |
| B ≤ F ≤ K | Intermediate |
| F = Q where Q > K | Advanced |

Where,
B denotes a Beginner rank threshold,
K denotes an Intermediate rank threshold, and
Q denotes an Advanced rank threshold whereas Q represents any value greater than K (i.e. Q > K).

In the next step, at step 162, the IVR communication system 100 determines the rank of user expertise according to the manner illustrated in Table. 1 above. If the value of the final score (F) is less than the value of the beginner rank threshold (B), the user is determined to belong in the Beginner rank of user expertise.

If the value of the final score (F) is greater than or equal to the value of B but less than or equal to the value of the intermediate rank threshold (K), the user is determined to belong in the Intermediate rank of user expertise.

If the value of the final score (F) is greater than the value of the intermediate rank threshold (K), which equals the value of the advanced rank threshold (Q), the user is determined to belong in the advanced rank of user expertise.

It is to be appreciated that the variables i₁ i₂ T₁ T₂ N, F, B, K, and Q correspond to all real numbers. Furthermore, a range of user-scores are associated to a rank amongst a plurality of user ranks corresponding to a range of user expertise. The user-scores correspond to at least one of the range of user-scores associated with the plurality of user ranks. Therefore, the user is classified as having one of the plurality of user ranks based on the user-score.

FIG. 1C illustrates a graphical illustration 190 of the user ranks corresponding to the first threshold score and the second threshold score in the context of the user scoring process 150 illustrated in FIG. 1B according to one of the embodiments of the present invention.

As shown, the Y-axis represents the final user-score (F) 191 of a user such as user 101. According to one of the embodiments of the invention, the Beginner rank threshold (B) 192 corresponds to the second threshold score (T₂) 193. Therefore, any value for the final user-score (F) 191 below the Beginner rank threshold (B) corresponds to classifying the user in the beginner user rank 194.

Similarly, the intermediate rank threshold (k) 195 corresponds to the first threshold score (T₁) 196. The intermediate user rank 197 corresponds to a range between the beginner rank threshold (B) 192 i.e. the second threshold score (T₂) 193 and the intermediate rank threshold (k) 195 i.e. the first threshold score (T₁) 196. Therefore, any value for the final user-score (F) 191 between the second threshold score (T₂) 193 and the first threshold score (T₁) 196 or equal to the second threshold score (T₂) 193 or the first threshold score (T₁) 196 corresponds to classifying the user in the intermediate user rank 194.

Similarly, any value above the intermediate rank threshold (k) 195 corresponding to the first threshold score (T₁) 196 represents the advanced user rank 198. Therefore, any value for the final user-score (F) 191 exceeding the first threshold score (T₁) 196 corresponds to classifying the user in the advanced user rank 198.

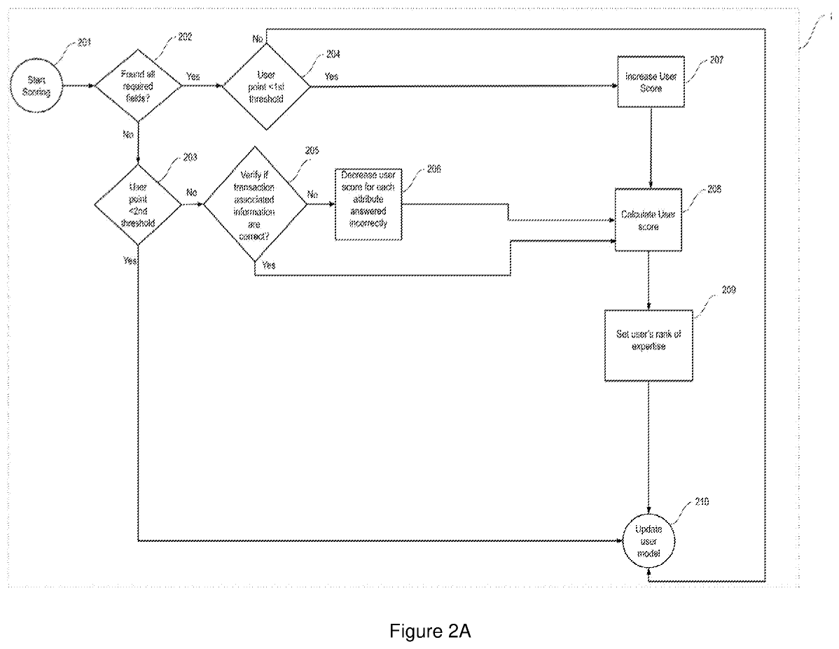

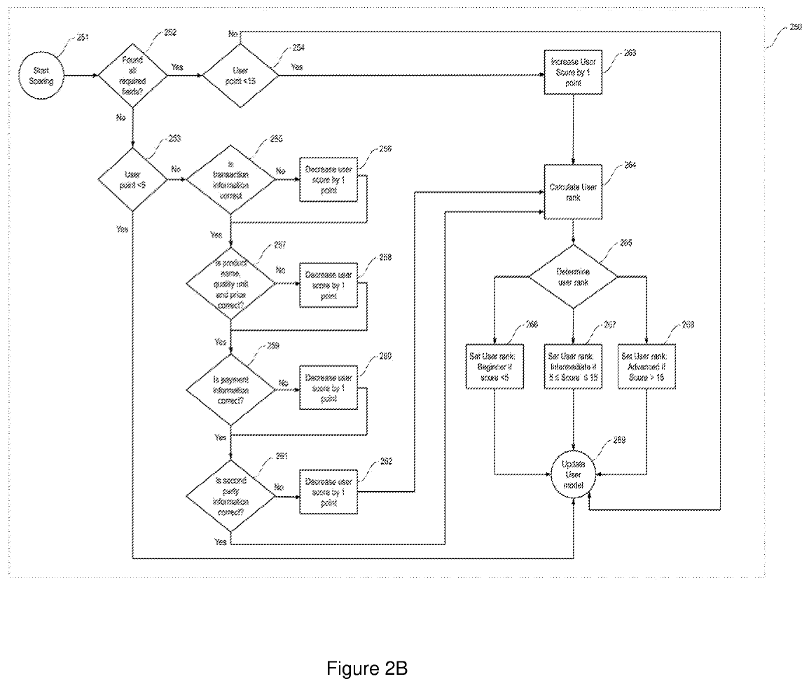

FIG. 2A is a flowchart illustrating a method 200 in the context of system 100 of FIG. 1 to determine the rank of user expertise through a user scoring process in an interaction session between the user and the IVR communication system 100 in accordance with one or more aspects of the present invention.

At step 201, when a user 101 calls and begins interacting with the IVR communication system 100, through the dialogue engine 103, in order to avail one or more services, the IVR communication system 100 starts the process of assigning a score to a user model associated with the user 101 to indicate the expertise of the user. According to one embodiment of the invention, if a user is new to the platform, the IVR communication system 100 generates a new user model for the user and assigns a user-score corresponding to a beginner rank using the user model update component 104 and updates the associated user model 105 based on one or more attributes. The attributes may include for example, but not limited to, user identification information, determined throughout the interaction session with the associated user. The identification information may include for example, but not limited to, one or more unique identifiers such as an MSISDN (Mobile Station Integrated Services Digital Network), Social Security Number, or a National Identification Number associated with the user. According to one embodiment of the present invention, the plurality of attributes may further include for example, financial transaction history, product name, quantity, unit, price, payment, goods, services and information related to other parties. According to an embodiment of the present invention, the plurality of attributes required for the process of user ranking is predetermined by an administrator of the IVR communication system 100. The information related to the plurality of attributes received from the user is recorded, stored and retrieved remotely from at least one of: the user model 105, a local storage medium, a web interface, an Application Programming Interface (API), a command line interface and a console.

As mentioned earlier, a new user is automatically set to a beginner rank of user expertise. The IVR communication system 100 generates a new user model associated with the user based on user identification information received from the user. However, if the usage is frequent and also if the user is a regular visitor of the service platform/application, the IVR communication system 100 is capable of updating the user model corresponding to the user by assigning a new score to elevate the rank of user expertise for the user based on the frequency of visits, usage and behavioural data and interaction. However, if the user is a past frequent visitor of the service platform/application but remains inactive for a certain period of time, the IVR communication system 100 is also capable of updating the user model based on the user rank by decrementing the user-score due to lack of usage, by assigning a new score, corresponding to an intermediate rank for example, assuming that the user needs to be guided across the service platform/application.

For the present invention, the user-scores can be generated, and/or updated based on usage and by incrementing or decrementing an existing user-score based on one or more attributes for the user model determined throughout the interaction with the user.

In the next step at step 202, the user rank classifier 106 analyzes the information related to the plurality of attributes received from the user and verifies if the user model satisfies all the required fields of information the IVR communication system 100 needs in order to proceed with the user scoring process. The required fields of information may include, but not be limited to, information related to a plurality of attributes received from a user during the voice-based interaction, information from the user model such as user behavioural data, user history associated with the service platform/application that may be indicative of the users rank of user expertise. The IVR communication system 100 then determines and assigns a first user-score for the user model based on the analysis of the corresponding information related to the plurality of attributes received from the user using the user model update component 104. The first user-score may also be the currently existing score for the rank of user expertise associated with a familiar user's user model assigning a first user-score to the user based on the analysis of corresponding information related to the plurality of attributes received from the user

If at step 202, the IVR communication system 100 verifies that all the required fields of information are satisfied, then in the next step, at step 204, the IVR communication system 100 verifies if the first user-score associated with the user 101 is less than a first threshold score. The first threshold score may be determined automatically or predetermined by an administrator of the IVR communication system 100.

If at step 204, the IVR communication system 100 verifies that the first user-score satisfies i.e. above the first threshold score, then the IVR communication system 100 determines the rank of user expertise to be a maximum based on the first user-score. The IVR communication system 100 then modifies, adjusts, or otherwise adapts the user interface based on the rank of user expertise and the user model associated with the user 101 at step 210.

If at step 204, the IVR communication system 100 verifies that the user model's first determined score does not satisfy the first threshold score, then at step 207 the IVR communication system 100 updates the user's first user-score through incrementing the user-score by one or more points in order to proceed with the user model scoring. The increment of the is the user-score desirable for many reasons including, but not limited to, to reward positive and successful usage of the IVR communication system 100 until the user, such as user 101, has reached a maximum user score. A higher score indicates better system knowledge and the threshold scores is used to define the knowledge of a user regarding the IVR communication system 100.

Then, in the next step at step 208, the IVR communication system 100 calculates a second score i.e. the final user-score in order to classify the user 101 to one of predetermined user ranks corresponding to a range of user expertise. The IVR system 100 is also capable of classifying the user as having one of the plurality of ranks of user expertise based on the first user-score.

According to one embodiment of the present invention, in the predetermined ranks of user expertise, a user can be classified as a beginner, intermediate, or an advanced user for the service platform/application, based on the user-score calculated at step 208. A range and/or thresholds of user-scores are classified for each of the aforementioned user ranks. Therefore, for each user-score associated with a user calculated at step 208 satisfies one of the ranks (beginner, intermediate, or advanced) in the IVR communication system 100. A user 101 is capable of upgrading from a beginner's rank of expertise to an intermediate then to an advanced depending on usage and/or the final user-score achieved in an interaction with the IVR communication system 100.

Referring back to step 202, if the IVR communication system 100 verifies that all the required fields of information are not satisfied, then in the next step at step 203, the IVR communication system 100 verifies if the user model's first user-score satisfies i.e. exceeds a second threshold score. The second threshold score may be determined automatically or predetermined by an administrator of the IVR communication system 100.

It is to be understood that the first threshold score value exceeds the second threshold score value. Furthermore, the IVR communication system 100 determines at least one of the first user-score-threshold and the second user-score-threshold corresponding to the plurality of attributes.

If at step 203, the IVR communication system 100 verifies that the user's first user-score does not satisfy i.e. less than the second threshold score, then at step 210 the IVR communication system 100 determines the rank of user expertise to be a minimum corresponding to the first user-score. The IVR communication system 100 then modifies, adjusts, or otherwise adapts the user interface i.e. the dialogue engine 103, based on the beginner rank of user expertise, and updates the user model 105 associated with the user 101 accordingly. The IVR system 100 is also capable of classifying the user as having one of the plurality of ranks of user expertise based on the first user-score.

The IVR communication system 100 is also capable of assigning a user rank to the user based on the first user-score and at least one of the first user-score-threshold and the second user-score-threshold.

If at step 203, the IVR communication system 100 verifies that the user's first user-score satisfies the second threshold score, then at step 205, the IVR communication system 100 verifies if information provided by the user 101related to the service is correct. Information related to service may include, but not limited to, attributes such as related financial transaction history, product name, quantity, unit, price, payment and information related to other parties involved.

If at step 205, the IVR communication system 100 analyzes and verifies that the information provided, by the user 101, related to the financial transaction, product or service is incorrect, then in the next step at step 206, the IVR communication system 100 updates the user model 105 by decrementing the user-score, for one or more information found incorrect in the information corresponding to the attributes, provided by the user 101, using the user model update component 104. This decrement of the user-score is desirable for many reasons including, but not limited to, an indication for something wrong such as a system error in the interaction session with the user 101 and/or at least some information corresponding to the attributes could not be extracted. Both of which indicates a potential lack of knowledge of the user 101 on how to input the data correctly in the IVR communication system 100.

Then, in the next step at step 208, the IVR communication system 100 calculates the final user-score in order to classify the user 101 to one of predetermined user ranks of user expertise.

If at step 205, the user rank classifier 106 verifies that the information provided, by the user 101, related to the financial transaction, product or service is correct, then the IVR communication system 100 proceeds to step 208 without decrementing the user-score and calculates the final user-score.

In another embodiment of the present invention, not illustrated herein, the user model update component 104 is implemented in a manner so that it is capable of verifying the information provided, by the user 101, related to the financial transaction, product or service is correct.

In the next step at step 209, the IVR communication system 100 determines and sets the rank of user expertise corresponding to the user-score calculated at step 208.

In the next step at step 210, the IVR communication system 100, updates the user model 105 associated with the user 101 and sets it with the rank of user expertise determined for the user. The IVR communication system 100 then adapts the rank of user expertise for the user model 105 associated with the user 101, and using the dialogue engine 103 provides the user with a user-interface based on the user rank. The dialogue engine 103 modifies, adjusts, and/or configures, and adapts the user interface according to the one of the plurality of ranks of user expertise the user is classified to.

It is to be understood that the user scoring can happen anytime, i.e. during or outside a voice based interaction whenever the IVR communication system 100 gets new information about the associated user which triggers the user scoring process. For the present scenario, the user 101 is in an interaction session with the IVR communication system 100. Therefore, the IVR communication system 100 scores and ranks the user real time. Furthermore, an administrator of the IVR communication system 100 is capable of changing the parameters of the scoring due to any change in the criteria of scoring associated with IVR communication system 100, which then triggers ranking of all existing users, regardless of whether they are in an interaction session with the IVR communication system 100 at the moment.

FIG. 2B illustrates a flow chart illustrating an exemplary scenario 250 in the context of IVR communication system 100 of FIG. 1 for a user scoring process performed for determining beginner, intermediate, and advanced rank users. In the exemplary scenario 250 illustrated in FIG. 2B, it is depicted that the IVR communication system 100 verifies the information provided by the user related to the product or service and updates the user-score based on the attributes accordingly in a step by step manner.

At step 251, when a user such as user 101 calls and begins interacting with the IVR communication system 100 in order to benefit from one or more services, the IVR communication system 100 starts the process of assigning a score to the user 101 associated with the user model 105.

In the next step at step 252, the IVR communication system 100 verifies if the user 101 satisfies all the required fields of information the IVR communication system 100 needs in order to proceed with the user scoring, such as identification information, and determines a first user-score for the user 101 based on the fields of information satisfied.

If at step 252, the IVR communication system 100 verifies the user 101 satisfies all the required fields of information the IVR communication system 100 needs in order to proceed with the user scoring process and is assigned a first user-score based on the fields of information satisfied, then in the next step, at step 254, the IVR communication system 100 verifies if the user's first user-score satisfies a first threshold score which is predetermined to be “15” for this exemplary scenario. If the user's first user-score does not satisfy the first threshold score i.e. less than 15, then the IVR communication system 100 updates the user model 105 associated with the user 101. The IVR communication system 100 increments the first user-score, using the user model update component 104, by a point and proceeds with the user scoring. The IVR communication system 100 then proceeds to step 264 and calculates the final user-score. It is to be appreciated that although the threshold score illustrated as being maintained in specific values, such values are not limited.

For example, if the user's first user-score was determined to be “11”, the IVR communication system 100 then updates the user model 105 associated with the user 101, through incrementing the first user-score by a point to reward positive and successful usage of the IVR communication system 100 until the user, such as user 101, has reached a maximum user score. Then in the next step at step 264, the IVR communication system 100 calculates the final user-score i.e. “12” in this exemplary scenario.

In the next step at step 265, the IVR communication system 100 determines the rank of user expertise corresponding to the user-score of “12” calculated at step 264. In this exemplary scenario 250, a user-score above or equal to 5 and below or equal to 15 corresponds to an intermediate rank. Therefore, the user 101 is determined to have the expertise of an intermediate rank user.

If at step 254, the IVR communication system 100 verifies that the user's first user-score exceeds the first threshold score “15”, then in the next step at step 261, the IVR communication system 100 determines the rank of user's expertise based on the first user-score to be a maximum, and ends the scoring process associated with the user 101. In this exemplary scenario 250, a user-score above 15 corresponds to a maximum score and therefore, the user 101 is determined to have the expertise of an advanced rank user.

It is to be understood that, the IVR communication system 100 classifies the user 101 to an advanced rank of user expertise when the first user-score exceeds the first threshold score.

If at step 252, the IVR communication system 100 verifies the user 101 does not satisfy all the required fields of information the IVR communication system 100 needs in order to proceed with the user scoring, then in the next step at step 253, the IVR communication system 100 verifies if the user's first user-score satisfies a second threshold score which is predetermined to be “5” for this exemplary scenario. It is to be appreciated that although the threshold score illustrated as being maintained in specific values, such values are not limited.

If at step 253, the IVR communication system 100 verifies the user's first user-score does not satisfy the second threshold i.e. the score is below “5”, the IVR communication system 100 determines the rank of user expertise to be a minimum based on the first user-score. The IVR communication system 100 then classifies the user to a beginner rank of user expertise as the first user-score lies within the second threshold score. Then, in the next step at step 269, the IVR communication system 100 updates the user model 105 associated with the user 101 and modifies, adjusts, or otherwise adapts the user interface based on the beginner rank of user expertise.

If at step 253, the IVR communication system 100 verifies the user's first user-score satisfies i.e. exceeds the second threshold score, then at step 255 the IVR communication system 100 starts verification of the financial transaction information, provided by the user 101 in the interaction session.

If at step 255, the IVR communication system 100 verifies that the information provided by the user 101 related to the financial transaction information is incorrect, then in the next step at step 256, the IVR communication system 100 updates the associated user model 105 by decrementing the user-score by 1 point. The IVR communication system 100 then proceeds to step 257. It is to be appreciated that although the points and scores are illustrated as being maintained in specific values, such values are not limited.

Referring back to step 255, if the IVR communication system 100 verifies that the information provided by the user 101 related to the financial transaction is correct, the IVR communication system 100 proceeds to step 257 without decrementing the user-score.

In the next step at step 257, the IVR communication system 100 verifies the information provided by the user 101 related to product name, quality unit and price. If at step 257, the IVR communication system 100 verifies that the information provided by the user related to product name, quality unit and price information is incorrect, then in the next step at step 258, the IVR communication system 100 updates the associated user model 105 by decrementing the user-score by a further 1 point. The IVR communication system 100 then proceeds to step 259.

Referring back to step 257, if the IVR communication system 100 verifies that the information provided by the user 101 related to product name, quality unit and price is correct, the IVR communication system 100 proceeds to step 259 without decrementing the user-score.

In the next step at step 259, the IVR communication system 100 verifies the information provided by the user 101 related payment information. If at step 259, the IVR communication system 100 verifies that the information provided by the user 101 related to payment information is incorrect, then in the next step at step 260, the IVR communication system 100 updates the associated user model 105 by decrementing the user-score by a further 1 point. The IVR communication system 100 then proceeds to step 261.

Referring back to step 259, if the IVR communication system 100 verifies that the information provided by the user 101 related to payment information is correct, the IVR communication system 100 proceeds to step 261 without decrementing the user-score.

In the next step at step 261, the IVR communication system 100 verifies the information provided by the user 101 related to second party information. If at step 261, the IVR communication system 100 verifies that the information provided by the user 101 related to second party information is incorrect, then in the next step at step 262, the IVR communication system 100 updates the associated user model 105 by decrementing the user-score by a further 1 point. The IVR communication system 100 then proceeds to step 264 and calculates the final user-score.

Referring back to step 261, if the IVR communication system 100 verifies that the information provided by the user 101 related to second party information is correct, the IVR communication system 100 proceeds to step 264 without decrementing the user-score.

It is to be understood that the first user-score associated with the user is updated to a second user-score when the first user-score lies within the first threshold score but exceeds the second threshold score. The IVR communication system 100 verifies the information related to the plurality of attributes received from the user when the first user-score exceeds the second threshold score but does not exceed the first threshold score. The IVR communication system 100 then decrements the first user-score associated with the user for each incorrect information.

In the next step at step 265, the IVR communication system 100 determines the rank of user expertise corresponding to the user-score calculated at step 264. For example, if the IVR communication system 100 verifies that the user 101, has provided incorrect information for steps 257, 259, and 261, then the user model 105 associated with user 101 is updated by a decrement of total 3 points for the user-score. For example, if the user's first user-score was determined to be “4”, the IVR communication system 100 then updates the user model associated with the user 101, by decrementing 3 points resulting in the final user-score to be “1” (4−(1*3)=1) at step 264. For illustration purposes only, if the final user-score is less than 5 at step 265, then the IVR communication system 100 corresponds to and sets the user rank as “Beginner” at step 266. Therefore, in this example, the user 101 is determined to belong in the beginner's rank of user expertise.

If the final user-score exceeds or equals to 5 but less than or equals 15, at step 265, then the IVR communication system 100 sets the user rank as “Intermediate” at step 266.

If the final user-score is greater than 15, at step 265, then the IVR communication system 100 sets the user rank as “Advanced” at step 266.

The Table. 2 below demonstrates an example of rank of user expertise classification with respect to user scores. It is to be appreciated that the table further demonstrates examples of possible scores for each rank of user expertise: from beginner (lower rank) to advanced (higher rank). It is to be appreciated that although the user-scores, ranges and thresholds illustrated as being maintained in specific values, such values are not limited.

TABLE 2

| user-score | Rank of User Expertise |
|---|---|
| Score <5 | Beginner |
| 5 ≤ Score ≤ 15 | Intermediate |
| Score >15 | Advanced |

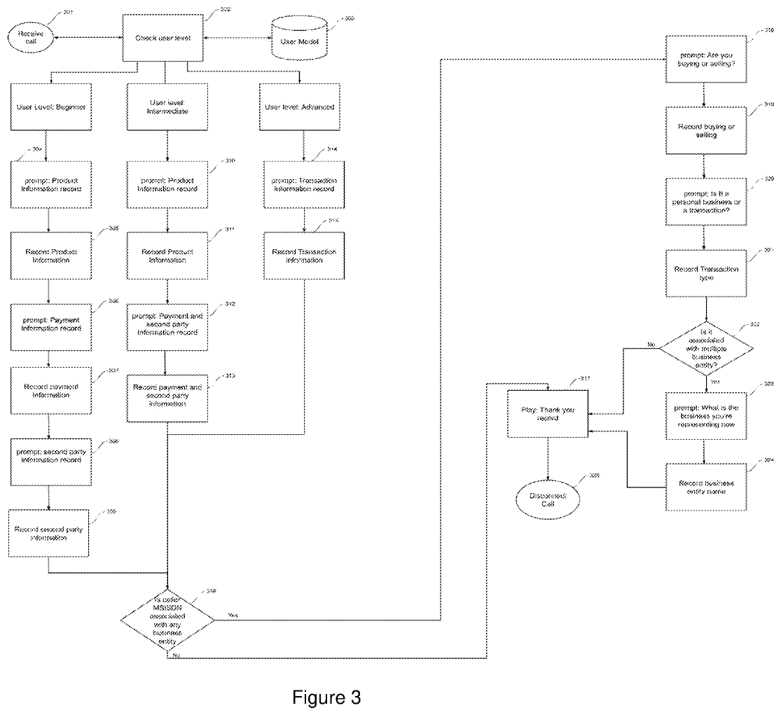

FIG. 3 is a flowchart illustrating an exemplary scenario in the context of system 100 of FIG. 1 to navigate the user through the user interface based on rank of user expertise in an interaction session between the user and the IVR communication system 100 for facilitating a financial transaction in accordance with one or more aspects of the present invention.

One of the aspects of the present invention relates using the user adaptation method in a business intelligence tool or as a means to facilitate financial transactions and record business data for example sales entry, purchase entry, money transaction entry, maintain user inventory, generate and send receipts, maintain consumer/suppliers accounts, tracking overdues, etc.

At step 301, the IVR communication system 100 receives a call initiated from the user such as user 101. The user 101 can make the call using any device capable such as client device 102, which could be a smartphone, feature phone or stationary phone and the call will land on the IVR communication system 100, which is running on cloud servers. In one of the embodiments of the present invention, the client device 102 is a smartphone and the call to IVR communication system 100 from user 101 is an app-based call corresponding to the IVR communication system 100.

At step 302, the IVR communication system 100 determines the rank of user expertise of the user 101 using the method illustrated in FIG. 2A.

At step 303, the IVR communication system 100 receives data from the user model such as user model 105. The user model 105 can be extracted from a personalized user database platform associated with a business for facilitating financial transactions.

If the IVR communication system 100 determines the rank of user expertise of the user 101 to be ‘beginner’ at step 302, then in the next step, at step 304, the IVR communication system 100 modifies, adjusts, or otherwise adapts the user interface based on the beginner rank of user expertise and the user model associated with the user. The adaptation may include, but not limited to, adding or removing features based on rank of user expertise and the user model. For the present exemplary scenario, for facilitating the financial transaction the user 101 wishes to engage in, the IVR communication system 100 generates a request, using the dialogue engine 103, to the user to input product information associated with the financial transaction.

In the next step, at step 305, the IVR communication system 100 records the product information received from the user 101.

In the next step, at step 306, the IVR communication system 100 generates a request to the user to input payment information associated with the financial transaction. The payment information includes for example, but not limited to, total payable, total amount paid by another party involved in that transaction or the total due by another party. The IVR communication system 100 requires any of the last two information as it can be derived using total bill and any of total paid or total due.

In the next step, at step 307, the IVR communication system 100 records the payment information received from the user 101.

In the next step, at step 308, the IVR communication system 100 generates a request to the user to input information for a second or other parties associated with the financial transaction.

In the next step, at step 309, the IVR communication system 100 records the information for the second or other parties received from the user 101.

If at step 302, the IVR communication system 100 determines the rank of user expertise of the user 101 to be ‘intermediate’, the IVR communication system 100 then modifies, adjusts, or otherwise adapts the user interface based on the intermediate rank of user expertise and the user model associated with the user 101.

In step 310, for an intermediate user the IVR communication system 100 will generate a request for the product information associated with the financial transaction.

In the next step, at step 311, the IVR communication system 100 records the product information received from the user 101.

In the next step, at step 312, for an intermediate rank user the IVR communication system 100 will generate a request for the payment information and information on second or other parties associated with the financial transaction. The IVR communication system 100 executes step 312 without interrupting the user to provide information for the aforementioned attributes separately.

In the next step, at step 313, the IVR communication system 100 records the payment information and information on second or other parties associated with the financial transaction received from the user 101.

If at step 302, the IVR communication system 100 determines the rank of user expertise of the user 101 to be ‘advanced’, the IVR communication system 100 then modifies, adjusts, or otherwise adapts the user interface based on the advanced rank of user expertise and the user model associated with the user 101.

In the next step, at step 314, for an advanced rank user the IVR communication system 100 will generate a request for only transaction information. The transaction information includes all the information aggregated of a transaction e.g. product list, quantity, second party information, payment information, aggregated and without any interruption by the IVR communication system 100.

In the next step, at step 315, the IVR communication system 100 records the transaction information received from the user 101.

After the IVR communication system 100 has received and recorded all the information associated with the transaction, in the next step at step 316, the IVR communication system 100 further determines if the user's MSISDN is associated with any business entity.

If at step 316, the IVR communication system 100 determines that the user's MSISDN is not associated with any business entity, then in the next step, at step 317, the IVR communication system 100 generates a “thank you” message to the user 101 and disconnects the call at step 325.

If at step 316, the IVR communication system 100 determines that the user's MSISDN is associated with a business entity, then in the next step at step 318, the IVR communication system 100 generates a request to provide information if the type of financial transaction is Buying or Selling.

In the next step, at step 319, the IVR communication system 100 records the information received from the user 101 regarding the type of financial transaction.

In the next step, at step 320, the IVR communication system 100 generates a request to provide information if the financial transaction is a personal or business transaction.

In the next step, at step 321, the IVR communication system 100 records the information received from the user 101 about whether the financial transaction is a personal or business transaction.

In the next step, at step 322, the IVR communication system 100 determines if the MSISDN for the user 101 is associated with multiple business entities. If at step 321, the IVR communication system 100 determines the MSISDN for the user 101 is associated with multiple business entities then in the next step at step 323, the IVR communication system 100 generates a request to provide information for the name of the business the financial transaction is associated with.

In the next step, at step 324, the IVR communication system 100 records the information received from the user for the name of the business the financial transaction is associated with. Then the IVR communication system 100 executes step 317, the IVR communication system 100 generates a “thank you” message to the user 101 and then disconnects the call at step 325.

Referring back to step 321, the IVR communication system 100 determines the MSISDN for the user 101 is not associated with multiple business entities then in the next step, at step 323, the IVR communication system 100 executes step 317. The IVR communication system 100 generates a “thank you” message to the user 101 and then disconnects the call at step 325.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be affected across a plurality of devices. Accordingly, the invention should not be limited to any single embodiment, but rather should be construed in breadth, spirit and scope in accordance with the appended claims.

1. A method of adapting user-interface of an interactive voice response system according to a user's expertise corresponding to a voice-based interaction, the method of adapting the user interface of the interactive voice response system comprising the steps of:
a. receiving information related to a plurality of attributes from a user during the voice-based interaction;
b. determining at least one of a first user-score-threshold and a second user-score-threshold corresponding to the plurality of attributes;
c. analyzing the information related to the plurality of attributes received from the user;
d. assigning a first user-score to the user based on the analysis of corresponding information related to the plurality of attributes received from the user;
e. assigning a user rank to the user based on the first user-score and at least one of the first user-score-threshold and the second user-score-threshold; and
f. providing the user with a user-interface based on the user rank.

2. The method of adapting user-interface of an interactive voice response system according to the user expertise corresponding to a voice-based interaction as claimed in claim 1, wherein the method of adapting the interactive voice response system's user-interface further comprising the steps of:
a. associating a range of user-scores to a user rank amongst a plurality of user ranks, the plurality of user ranks corresponding to different levels of user expertise.

3. The method of adapting user-interface of an interactive voice response system according to the user expertise corresponding to a voice-based interaction as claimed in claim 1, wherein the method of adapting the interactive voice response system's user-interface further comprising the steps of:
a. configuring, modifying and adjusting the user interface according to the one of the plurality of user ranks the user is classified to.

4. The method of adapting user-interface of an interactive voice response system according to the user expertise corresponding to a voice-based interaction as claimed in claim 3, wherein configuring, modifying and adjusting the user interface according to the user rank includes providing a plurality of services to the user in a step manner wherein the number of steps is dependent on the user's rank.

5. The method of adapting user-interface of an interactive voice response system according to the user expertise corresponding to a voice-based interaction as claimed in claim 4, wherein providing the plurality of services includes providing at least one of: financial transaction management.

6. The method of adapting user-interface of an interactive voice response system according to the user expertise corresponding to a voice-based interaction as claimed in claim 1, wherein the first user-score corresponds to at least one of the range of user-scores associated with the plurality of user ranks.

7. The method of adapting user-interface of an interactive voice response system according to the user expertise corresponding to a voice-based interaction as claimed in claim 1, wherein the plurality of user ranks include at least one of a beginner, an intermediate, and an expert.

8. The method of adapting user-interface of an interactive voice response system according to the user expertise corresponding to a voice-based interaction as claimed in claim 1, wherein the plurality of attributes include at least one of identification information, financial transaction history, product name, quantity, unit, price, payment and information related to other parties.

9. The method of adapting user-interface of an interactive voice response system according to the user expertise corresponding to a voice-based interaction as claimed in claim 1, wherein the first threshold score and the second threshold score are determined either automatically or set by an administrator.

10. The method of adapting user-interface of an interactive voice response system according to the user expertise corresponding to a voice-based interaction as claimed in claim 9, wherein the first threshold score exceeds the second threshold score.

11. The method of adapting user-interface of an interactive voice response system according to the user expertise corresponding to a voice-based interaction as claimed in claim 1, wherein the method of adapting the interactive voice response system's user-interface further comprising the steps of:
a. classifying the user to an advanced user rank when the first user-score exceeds the first threshold score.

12. The method of adapting user-interface of an interactive voice response system according to the user expertise corresponding to a voice-based interaction as claimed in claim 1, wherein the method of adapting the interactive voice response system's user-interface further comprising the steps of:
a. updating the first user-score associated with the user to a second user-score when the first user-score lies within the first threshold score and the second threshold score.

13. The method of adapting user-interface of an interactive voice response system according to the user expertise corresponding to a voice-based interaction as claimed in claim 1, wherein the method of adapting the interactive voice response system's user-interface further comprising the steps of:
a. classifying the user to a beginner user rank when the first user-score lies within the first threshold score and the second threshold score.

14. The method of adapting user-interface of an interactive voice response system according to the user expertise corresponding to a voice-based interaction as claimed in claim 1, wherein the method of adapting the interactive voice response system's user-interface further comprising the steps of:
a. verifying the information related to the plurality of attributes received from the user when the first user-score exceeds the second threshold score and lies within the first threshold score; and
b. decrementing the first user-score associated with the user for each incorrect information.

15. The method of adapting user-interface of an interactive voice response system according to the user expertise corresponding to a voice-based interaction as claimed in claim 1, wherein the method of adapting the interactive voice response system's user-interface further comprising the steps of:
a. updating the user model associated with the user based on data corresponding to frequency of visits, usage, recorded voice-based interaction data, behavioral data; and
b. updating the user model associated with the user based on the user rank.

16. A method of ranking a user of an interactive voice response system according to the user's expertise corresponding to a voice-based interaction, the method of ranking the user comprising the steps of:
a. receiving information related to a plurality of attributes from the user during the voice call;
b. determining at least one of a first user-score-threshold and a second user-score-threshold corresponding to the plurality of attributes;
c. analyzing the information related to the plurality of attributes received from the user;
d. assigning a first user-score to the user based on the analysis of corresponding information related to the plurality of attributes received from the user; and
e. assigning a user rank to the user based on the first user-score and at least one of the first user-score-threshold and the second user-score-threshold.

17. The method of ranking a user of an interactive voice response system according to the user's expertise as claimed in claim 16, the method of ranking the user further comprising the steps of:
a. associating a range of user-scores to a rank amongst a plurality of user ranks corresponding to different levels of user expertise.

18. The method of ranking a user of an interactive voice response system according to the user's expertise as claimed in claim 16, the method of ranking the user further comprising the steps of:
a. configuring, modifying and adjusting the user interface according to the one of the plurality of user ranks the user is classified to.

19. The method of ranking a user of an interactive voice response system according to the user's expertise as claimed in claim 16, wherein the first user-score corresponds to at least one of the range of user-scores associated to a rank amongst the plurality of user ranks.

20. The method of ranking a user of an interactive voice response system according to the user's expertise as claimed in claim 16, the method of ranking the user further comprising the steps of:
a. classifying the user to an advanced user rank when the first user-score exceeds the first threshold score.

21. The method of ranking a user of an interactive voice response system according to the user's expertise as claimed in claim 16, the method of ranking the user further comprising the steps of:
a. updating the first user-score associated with the user to a second user-score when the first user-score lies within the first threshold score but exceeds the second threshold score.

22. The method of ranking a user of an interactive voice response system according to the user's expertise as claimed in claim 16, the method of ranking the user further comprising the steps of:
a. classifying the user to a beginner user rank when the first user-score does not exceed the second threshold score.

23. The method of ranking a user of an interactive voice response system according to the user's expertise as claimed in claim 16, the method of ranking the user further comprising the steps of:
a. verifying the information related to the plurality of attributes received from the user when the first user-score exceeds the second threshold score and lies within the first threshold score; and
b. decrementing the first user-score associated with the user for each incorrect information.

24. The method of ranking a user of an interactive voice response system according to the user's expertise as claimed in claim 16, the method of ranking the user further comprising the steps of:
a. updating the user model associated with the user based on frequency of visits, usage, recorded voice-based interaction data, behavioral data and interaction; and
b. updating the user model associated with the user based on the user rank.

25. A system (100) for adapting an interactive voice response system's user-interface according to a user's expertise corresponding to a voice-based interaction, the system (100) comprising:
a dialogue engine (103) for handling interaction with a user;
a user model (105) for storing the user information;
a user model update component (104) for monitoring and speculating the interaction between the user and the dialogue engine (103) to update the user model (105) with any new information;
a user rank classifier (106), the user rank classier (106) assigns a user rank to a user based on a first user-score and at least one of a first user-score-threshold and a second user-score-threshold; and
the dialogue engine (103) provides the user with a user-interface based on the user rank.

26. The system (100) of adapting an interactive voice response system's user-interface according to a user's expertise corresponding to a voice-based interaction, as claimed in claim 25, wherein the dialogue engine (103) receives information related to a plurality of attributes from the user during the voice based interaction; and the user rank classifier (106) determines at least one of a first user-score-threshold and a second user-score-threshold corresponding to the plurality of attributes.

27. The system (100) of adapting an interactive voice response system's user-interface according to a user's expertise corresponding to a voice-based interaction, as claimed in claim 25, wherein the user rank classifier (106) is further capable of: associating a range of user-scores to a rank amongst a plurality of user ranks corresponding to different levels of user expertise.

28. The system (100) of adapting an interactive voice response system's user-interface according to a user's expertise corresponding to a voice-based interaction, as claimed in claim 25, wherein the user model update component (104) is capable of: updating the user model (105) associated with the user based on a recorded voice-based interaction data.

29. The system (100) of adapting an interactive voice response system's user-interface according to a user's expertise corresponding to a voice-based interaction 1, as claimed in claim 25, wherein the user model update component (104) is capable of: updating the user model (105) associated with the user based on frequency of visits, usage, recorded voice based interaction data, behavioral data and interaction; and updating the user model (105) associated with the user based on the user rank.
